(19) United States
(12) Patent Application Publication
(10) Pub. No.: US 2016/0015480 A1
(43) Pub. Date: Jan. 21, 2016

(54) DENTAL MATRIX CLAMP

(71) Applicant: Zachary Korwin, Philadelphia, PA (US)

(72) Inventor: Zachary Korwin, Philadelphia, PA (US)

(21) Appl. No.: 14/576,258

(22) Filed: Dec. 19, 2014

Related U.S. Application Data
(60) Provisional application No. 62/027,212, filed on Jul. 21, 2014.

(51) Int. Cl. A61C 5/12

(52) U.S. Cl. CPC A61C 5/122; A61C 5/125

(57) ABSTRACT

A ring clamp matrix system utilizes a split ring spring with a pair of feet, one mounted to each end of the ring. At least one of the feet includes a wedging surface for engaging and holding a sectional matrix foil. Each foot is positioned outwardly from the interproximal space as the ring clamp is being installed between two adjacent teeth, to have each foot exert a force inward against the teeth and foil under the force of the spring when the spring is permitted to retract to its natural shape. A pair of juxtaposed extensions, each extend in the orthogonal direction, respectively inwardly towards each other from the bottom of each foot. These extensions are retained in position by the respective curved surfaces of the teeth to force the foil against one of the two teeth and positively lock the ring clamp from moving out of position.

### CROSS-REFERENCE TO RELATED APPLICATION

This application is based upon and claims priority of provisional application No. 62/027,212, filed Jul. 21, 2014, for a ring clamp, which provisional application is incorporated herein by reference in its entirety.

### BACKGROUND OF THE INVENTION

1. Field of the Invention

The present invention is directed to an appliance facilitating Class II tooth restoration of a molar. Specifically, it is directed to a matrix system for closing off a reduced side face of a tooth before a restorative filling.

2. Brief Description of the Prior Art

The drilling out of a cavity in a tooth at times requires the drilling way of part of the side wall of the tooth, thereby requiring a containment “form” at the drilled-out tooth face to contain the filling material and establish the shape of the side wall of the filling. There have been various appliances used for creating the Class II restoration molding form. With amalgam fillings the classic appliance was a reasonably rigid band inserted over the tooth and tightened down against the tooth with a tool. One or two wedges were inserted at the gum line in the interproximal region to limit the expansion of the amalgam under the band in order to seal off the gingival embrasure area.

After polymer filing material became more prevalent, matrix appliances were developed to accommodate restoration with polymer material. One difference between polymer and amalgam materials is that polymer materials do not expand when cured. Thus various matrix systems were developed to perform Class II restorations with polymer materials.

A popular matrix system is the TOFFLEMIRE matrix system which in one embodiment uses a flexible foil band held tight around the tooth with a tool. The tool tightens the flexible band and cinches it. Wedges are then inserted at the gum line. The band is removed by reversing the cinch. This device has proved awkward and time consuming to use.

Alternatives to the Tofflemire matrix system are generally called sectional matrix systems. Two well known sectional matrix systems are the GARRISON matrix system and the TRIODENT matrix system.

The GARRISON matrix system uses a flexible foil form which is concave in two directions to approximate the curved shape of a bud-like protrusion of tooth material. The foil form is first inserted between the teeth using pliers or forcipes, with the cupped side facing the reconstruction site. A wedge is then inserted between the teeth in the interproximal region to hold the bottom of the foil form against the reconstruction site. The Garrison system then uses a split ring-shaped, spring clamp to hold the sides of the foil against the reconstruction site. This clamp has two feet, one at each end of the split ring. Each foot is approximately rectangular with a V-tapered outer face. The V-shape is intended to fit into the space between the teeth so that the feet engage the surfaces of the two teeth and force the foil to wrap around the reconstruction site.

Once in place, reconstruction can begin. The Garrison matrix is assembled within the patient's mouth with each member being inserted in turn. This is a delicate and time consuming procedure. If the Garrison matrix ring clamp is not installed carefully, it can accidentally pop-off in the patient's mouth, or onto the patient, or onto the floor. This requires the installation procedure to be conducted again. If during reconstruction of the tooth, the patient inadvertently moves, and the ring is touched, the ring feet can lose their grip and the Garrison ring clamp can again accidentally pop-off.

The TRIODENT matrix system addresses the pop-off issue of the Garrison matrix ring clamp. Triodent uses the same type of curved foil form which is placed between the teeth with tweezers or forcipes. It also uses the same type of wedge which is inserted at the gum line using a forcipes for wedging between the teeth to force the foil toward the reconstruction site. The Triodent ring clamp has feet at each end, which each incorporate a rectangular end pad with a V-shaped outer face, similar to Garrison. However, Triodent has added a downward projecting, slightly curved, arm at the end of each foot. This arm engages the curved surface of the molar and holds the foot fixed against the tooth sides with a spring force. The curvature of the arm positions the end of each arm inside the widest part of the tooth to prohibit the Triodent ring clamp from accidentally popping off.

However, the Triodent matrix system, like the Garrison system, must be assembled sequentially (piecemeal) in the patient's mouth. The Triodent assembly is time consuming and delicate procedure which is at times uncomfortable for the patient.

What is desired is an improved matrix system which can be assembled outside of the patient's mouth and inserted in the patient's mouth as a completed assembly, in one step.

What is also desired is such an improved matrix system which will not accidentally pop-off.

What is also desired is an improved matrix system which eliminates the need for separate wedges to be inserted once the foil is in place.

### SUMMARY OF THE INVENTION

The objects of the present invention are realized in a ring clamp sectional matrix system which is capable of being assembled outside of the mouth and then inserted between two teeth in a single operation. A sectional matrix, being a shaped foil member, is needed to be fixed against the reduced side wall of a tooth undergoing Class II reconstruction. Typically the tooth is a molar to be filled with a polymer material. The purpose of the sectional matrix is to shape and retain the polymer filling material at the face of the tooth.

A molar typically has a plurality of buds extending about its outward face resulting in an inward curvature of the tooth adjacent the gum.

A split ring is made of stainless steel spring material with a closing tension force. This ring is circular in shape, and sized from about five-eighth inches in diameter to one and one-quarter inches in diameter, being available in a selection of sizes, including small, medium and large for various size teeth. The ring is intended to fit over about two molars.

The ring can be spread open by a pair of reverse pliers with curved gripping ends. These pliers are manipulated to engage the ring at about its diametric mid-point, being about half way from front to back. The split ends are to be considered the front of the ring. These pliers can be used to install the clamp assembly, and thereafter remove it.

A polymer foot is attached to each of the ends of the ring. Each foot can be molded or machined from any of a plurality of thermo polymer materials, including polyester, polypropylene, polyvinyl chloride, or other such non-toxic materials made with a formula which provides a soft, and somewhat pliable material. Where possible each foot has rounded surfaces and is glued or heat welded to the ring material.

At least one of the feet has a wedging face for gripping the upper and lower edges of a sectional matrix. While both feet can be made with gripping surfaces which would make them mirror images of each other, a preferred embodiment has only one of the feet with gripping surfaces.

The sectional matrix is chosen in various sizes, including small, medium and large to fit the patient's tooth (teeth). This necessitates that the gripping surface on a foot is accordingly sized as small, medium and large.

The sectional matrix units can be purchased commercially from various vendors including suppliers of Metal Pinch™ product. The commercial product has a double curvature to fit around and against the rounded surfaces of a molar.

The gripping foot has a C-shaped side view created by the front section of the material being machined out of the body. A top and a bottom walls extend in parallel outwardly from the body of the foot. The inside face of the top wall has a step down section. The inside face of the bottom wall has a bump out (raised portion) at its outer edge (lip). The top and bottom edges of the sectional matrix foil are pressed into the C-shaped section to have the foil top edge wedge against the corner where the back face of the C-section meets the top wall, and the foil bottom edge to be caught and retained by the bottom bump out. The bottom bump out is rounded (dome shaped) to facilitate bottom edge of the sectional matrix sliding over it to be retained by the inside of the dome shaped raised feature.

Positioned below the inside face of each bottom wall is an orthogonal projection. This pair of projections is juxtaposed and facing each other to extend through the gingival margin when the ring is installed and the feet are each in position against the facing walls of the two adjacent teeth. These projections substitute for gingival wedges.

The method of installation of the present invention in a patient's mouth, and its later removal, requires a series of steps. A ring size is selected, with matching sized feet. A matching sized sectional matrix is selected. The matrix is wedged into one foot to be securely held there by the spring action of the sectional matrix against the back wall of the foot and its forward positioned bump out. Once installed, the assembly is inserted in the mouth with the sectional matrix being inserted between the two teeth facing the reduced tooth. This is done by spreading the ring clamp and positioning the sectional matrix between the two teeth. The ring clamp is opened far enough to clear the gingival projections while the ring is manipulated around the teeth. When the feet of the ring clamp are positioned against the two teeth and the back face of the sectional matrix, the ring clamp is released and the gingival projections are moved toward each other to extend beyond each other's points to overlap with one another.

Thus, the sectional matrix is securely in place and the ring clamp cannot be dislodged accidentally. Moreover, the position of the gingival projections with respect to the bottom edge of the sectional matrix remains a predetermined distance, which is fixed. To remove the device the process is reversed.

The closing spring force of the ring keeps the two gingival projections forcibly positioned against one another, against the two teeth and against the matrix.

The present invention provides several advantages over the other devices. It is pre-assembled entirely outside of a patient's mouth. It eliminates the need for a separate gingival wedge(s), and the separate installation and removal of wedges. It assures that the ring clamp will not accidentally pop-off.

### BRIEF DESCRIPTION OF THE DRAWINGS

The features, advantages and operation of the present invention will become readily apparent and further understood from a reading of the following detailed description with the accompanying drawings, in which like numerals refer to like elements, and in which:

FIG. 1 is a perspective view of the ring clamp embodiment of the invention applied between two teeth;

FIG. 2 is perspective view of the ring embodiment of FIG. 1 showing a matrix foil held by the feet of the clamp;

FIG. 3 is a top plan view of the ring clamp compressed to its spring size;

FIG. 3a is a cross-sectional view of the ring taken as shown in FIG. 3;

FIG. 4 is a bottom plan view of the ring of FIG. 3;

FIGS. 5a, 5b and 5c are top, end and side views, respectively, of a prior art interproximal wedge used in tooth restoration;

FIGS. 6a and 6b are face and top plan views, respectively, of a prior art sectional matrix used in tooth restoration;

FIGS. 7a and 7b are side and front-face views, respectively, of the first foot of the ring clamp of FIGS. 3 and 4;

FIGS. 8a and 8b are side and front-face views, respectively, of the second foot of the ring claim of FIGS. 3 and 4;

FIGS. 9a and 9b are side and front-face views, respectively, of the first foot holding a sectional matrix;

FIGS. 10a and 10b are side and front-face views, respectively, of the second foot engaging a sectional matrix;

FIG. 11 shows a top view of a sectional matrix of the invention with a rearward top edge roll;

FIG. 12 shows a front-face view of the rearward top edge roll sectional matrix of FIG. 11;

FIG. 13 is a cross-sectional view of the sectional matrix taken as shown in FIG. 11;

FIG. 14 is a cross-sectional view of a sectional matrix with a forward top edge roll;

FIG. 15 is a top plan view of an alternate X-shaped clamp embodiment;

FIG. 16 is a top plan view of the embodiment of FIG. 15 with the feet altered;

FIGS. 17a and 17b show a side and front-face views of the first foot of FIGS. 7a, 7b, with a curved horizontal gutter;

FIG. 18 shows the side view foot of FIG. 17a with a rear roll sectional matrix snapped into the gutter;

FIG. 19 shows a side view of the first foot of FIG. 17a with an alternate gutter position; and

FIG. 20 shows the first foot of FIG. 19 with a front roll sectional matrix snapped into the alternate gutter position.

### DETAILED DESCRIPTION

The present invention is dental matrix clamp assembly for clamping a dental sectional matrix structure against the wall of a tooth for Class II restoration.

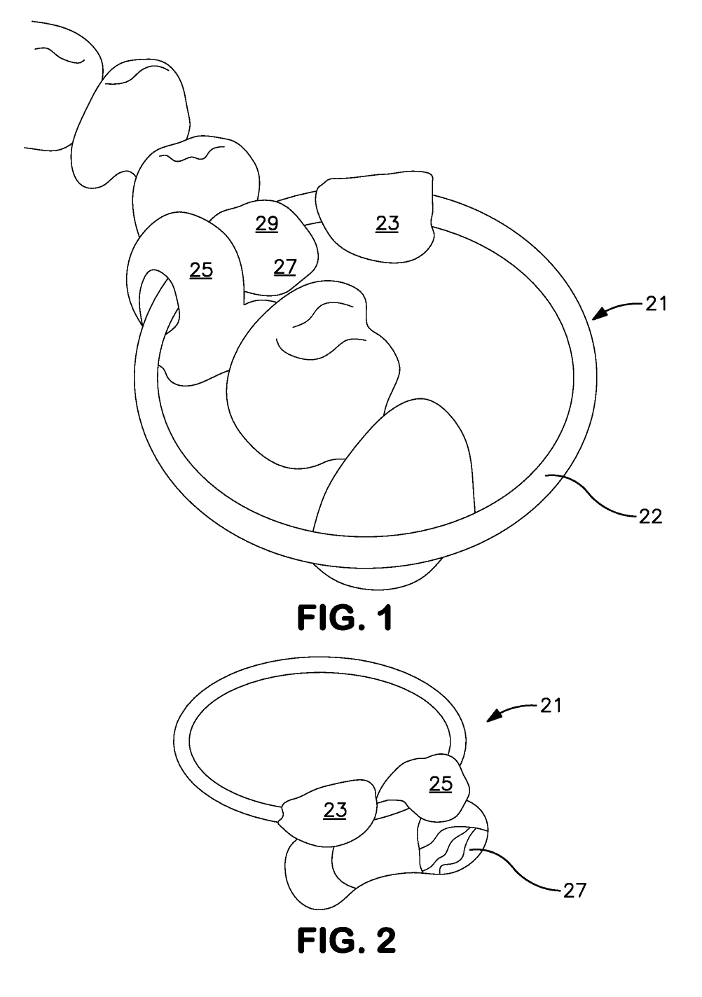

FIG. 1 shows a sectional matrix ring clamp 21 inserted between two teeth having a split ring member 22 with a first foot 23 at a first free end of the split ring 22, and a second foot 25 at a second fee end of the ring 22. At least one of the feet 23, 25 holds the sectional matrix 27 securely as the clamp 21 assembly is inserted in a patient's mouth. In order to position the clamp 21 and matrix 27 to be positioned between two teeth, the ring 22 is spread open with a tool held by the dentist. After the clamp 21 assembly is positioned between two teeth, and matrix 27 abuts the restoration tooth 29, the tool releases the ring 22 and the spring 21 is permitted to return to its original size, where both feet press into the interproximal region and against the matrix 27 to hold the matrix against the wall of a tooth 29 being restored.

FIG. 2 shows a front perspective view of the ring clamp 21 with a matrix held securely by the first foot 23. A sectional matrix 27 is chosen in size and shape to match the tooth being restored. The ring 22 may also be supplied in different sizes. However, two or three sizes, small, medium, and large, are sufficient for most patient situations. The size of the ring 22 and the size and shape of the matrix 27 are chosen to suit a patient's mouth and teeth. Where the matrix 27 is reasonably small, the matrix 27 may be secured to both feet 23, 25, while the clamp 21 and matrix 27 are being inserted between two teeth. With a larger matrix 27, such as for an adult, only one of the feet, holds the matrix while the clamp is being positioned (inserted) between teeth. This eliminates a torque or bending force on the matrix as it is being inserted. This bending force arises when a ring 22 and matrix 27 are larger and the support position of the matrix between the feet is larger. The torque or bending force can occur as the matrix contacts a rounded tooth surface with the rounded portion of the matrix.

In use, the clamp 21 and matrix 27 are pre-assembled outside of the patient's mouth. The matrix 27 is secured to one or both feet, manually. Then a grasping and spreader tool expands the ring 22 and the tool is used to position the clamp 21 at the appropriate location in the mouth. The tool then releases the ring and the tool is removed from the patient's mouth. When released, the ring 22 contracts toward its original configuration. In so doing, a force is asserted by the feet 23, 25 to position the matrix 27 against the restoration wall of the restoration tooth 29. A force is also asserted between the two teeth in the interproximal direction to assure that the clamp 21 does not move while the dentist is working on the restoration tooth 29.

After the tooth 29 is restored, the tool is used to spread the ring 22 and remove the clamp 21 and matrix 27 assembly from the patient's mouth.

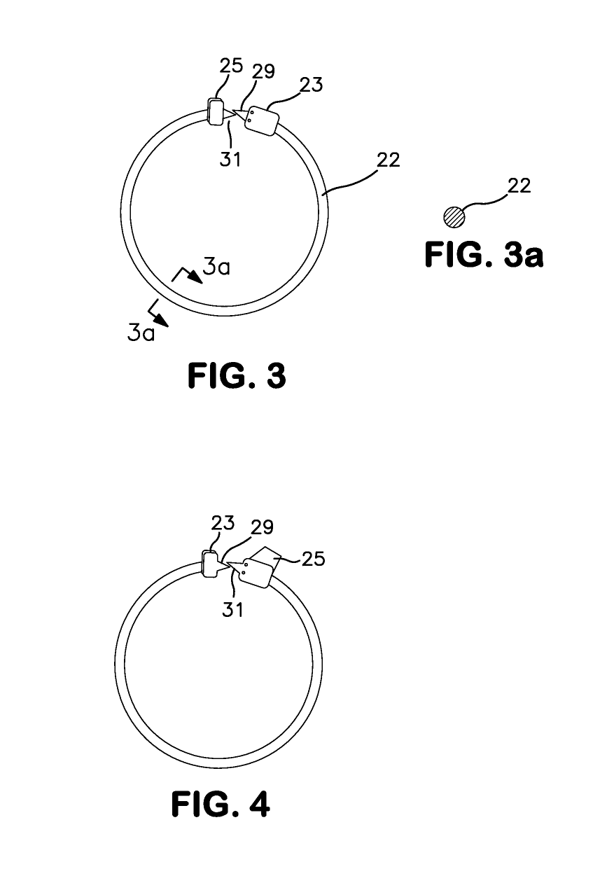

The ring clamp, FIGS. 3 and 4, has an oval shaped stainless steel wire split ring 22, made from circular cross-sectional spring steel, FIG. 3a. Molded thermoplastic feet 23, 25, are positioned at each end of the split ring 22. The feet 23, 25 are rectangular-shaped and each has a triangular shaped wedge 29, 31, respectively, extending from the bottom. The wedges 29, 31 extend towards each other and overlap, FIG. 4, when the spring ring 22 contracts, FIG. 4. The wedges 29, 31 are molded into and as a part of their respective foot, 23, 25, and are of the same thermoplastic material.

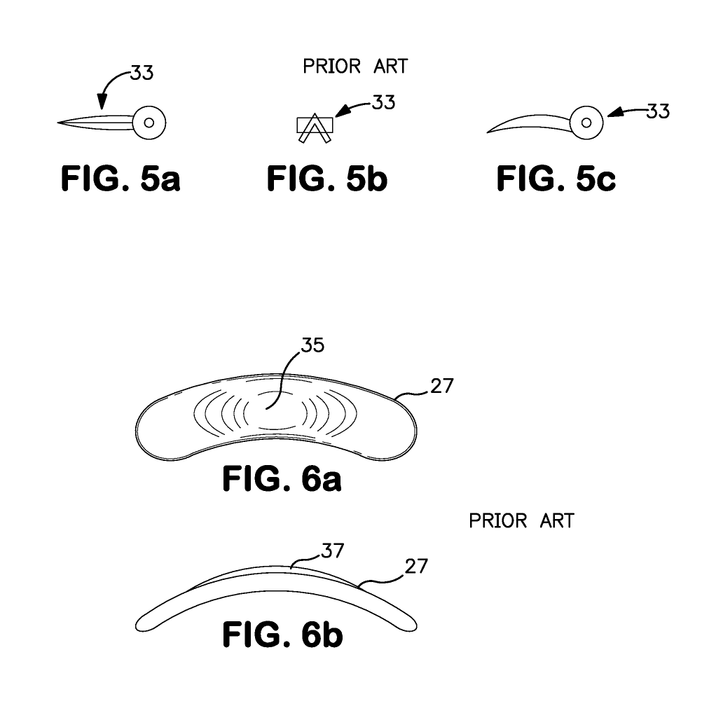

The purpose of the wedges 29, 31, on the feet 23, 25, is to exert a pressure in the interproximal region between two teeth, and to seal the gingival margin when the ring 22 is released by the tool and able to contract. These wedges 29, 31 eliminate the need for a commercially available wedge 33, FIGS. 52, 5b, 5c. Commercial wedges 33 can have a triangular cross-section, FIG. 5b, and are slightly curved, FIG. 5c. However, these commercially available wedges 33 need to be separately, manually inserted and manually removed. They are difficult to grasp, and when inserted from both sides of the gum are difficult to position and remove.

A sectional matrix 27 used in the present invention, FIGS. 6a and 6b is made of in curved shape from somewhat pliable and somewhat springy metal foil, often stainless steel foil. The curved foil also has a bubble shaped area 35 which creates a bulge 37 of the back face of the foil matrix 27. The compound curvature shape of each matrix 27 conforms to the shape of the tooth sidewall being restored.

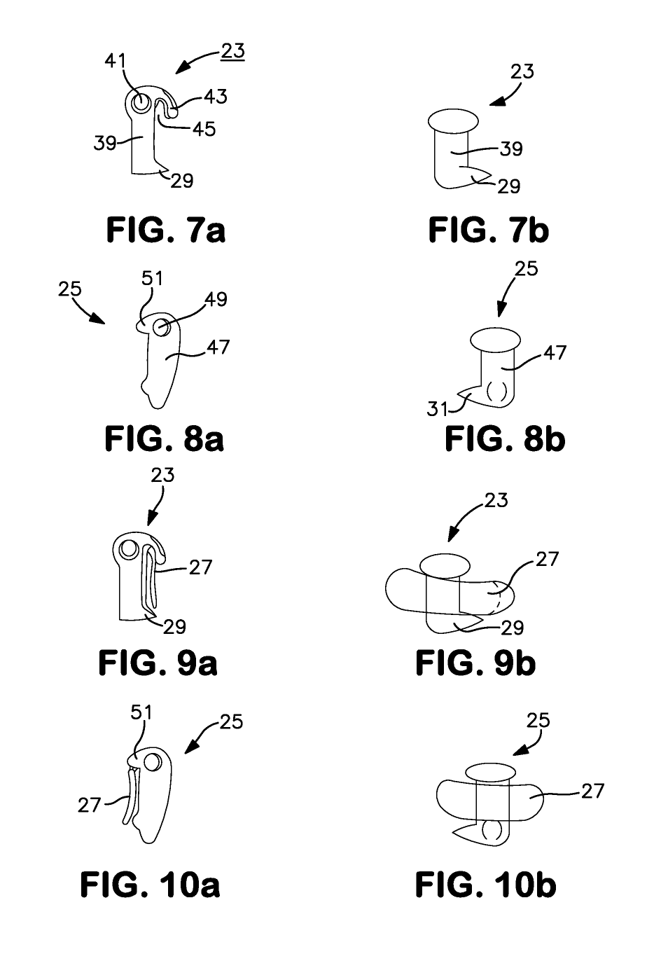

The first foot 23 is shown in a side view and a face view, respectively in FIGS. 7a and 7b. The body 39 of the first foot 23 is elongate and essentially rectangular in cross section. However, other convenient shapes may be used. A hole 41 extends through the body 39 for mounting the foot on a first end of the split ring 22. The foot 23 may be glued or thermo welded or otherwise permanently secured to the ring 22. The triangular-shaped wedge 29 is molded into the bottom of the body 39 to extend in an orthogonal direction to the side of the face, FIG. 7b.

A lip 43 extends outwardly and downwardly from the front-face side of the foot 23. The shape of the lip 43, FIG. 9a, creates a cavity 45 into which the top edge of a matrix 27 is inserted to be held securely by the foot 23. The bottom of the matrix 27 can be positioned against a top face of the orthogonal, FIG. 9b.

The second foot 25, FIGS. 8a and 8b, can have a similarly-shaped body to the first foot 23 with a ring 22 mounting hole 49 extending through it. The second foot 25 has a top projection 51 extending outwardly from its front-face side. The second wedge 31 of the second foot 25, FIG. 8b, extends in an orthogonal direction towards the first foot 23, first wedge 29. A hemispherical projection is positioned on the front-face side of the second foot 24 near the bottom. When on end of a matrix 27 is mounted on and held by the first foot 23, the other end of the matrix 27 seats against the second foot 25 between its top projection 51 and its bottom hemispherical projection 53, FIGS. 10a and 10b.

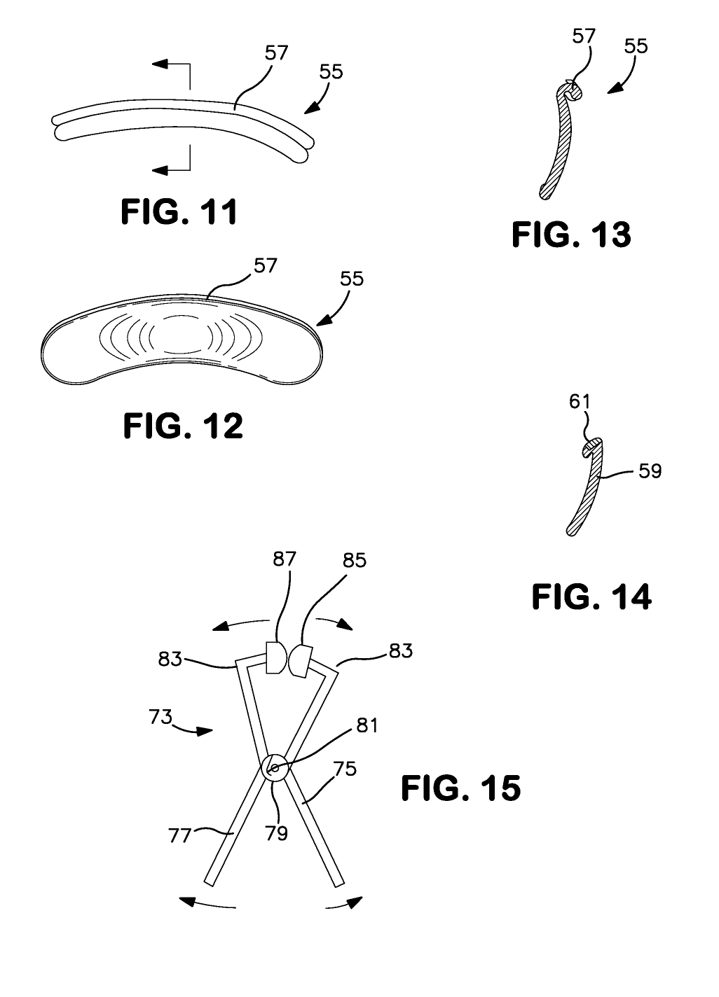

The holding ability by the feet, of a sectional matrix 55, FIGS. 11, 12, 13, can be enhanced by modifying the matrix 55. This modification includes a rearward rolled edge 57, FIG. 13, at the top edge of the matrix 55. The rearward top edge roll 67 strengthens the matrix 55 material.

In the alternative, a sectional matrix 59 can be modified with a forward rolled edge 61, FIG. 14, again at the top edge of the matrix 59, which again strengthens the matrix 59 material.

The first foot 63 is modified with a round gutter 65 extending horizontally across its front-face side, FIGS. 17a and 17b. This gutter 65 is sized to receive the rearward top edge roll 57 of the matrix 55. The matrix roll 57 snaps into the gutter 65 resulting in the matrix 55 being held securely by the first foot 65, FIG. 18.

Alternately, the first foot 67 can be modified with a gutter 69 extending horizontally across the bottom face to the top projection 71, FIG. 19. In this embodiment the forward rolled edge matrix 59 can be snapped into this gutter 69 to be held securely, FIG. 20.

The ring 22 is oval shaped being wider in the direction across a tooth and shorter in a direction along a tooth. This permits the tool to engage the ring 22 for positioning and removal with being interfered by a tooth structure. The oval shorter diameter length is about 75 percent the distance of the longer diameter length. An example size for the ring 22 is about 2 cm in diameter, with the longer diameter being about 2.5 cm in length and the shorter diameter being about 1.8 cm in length.

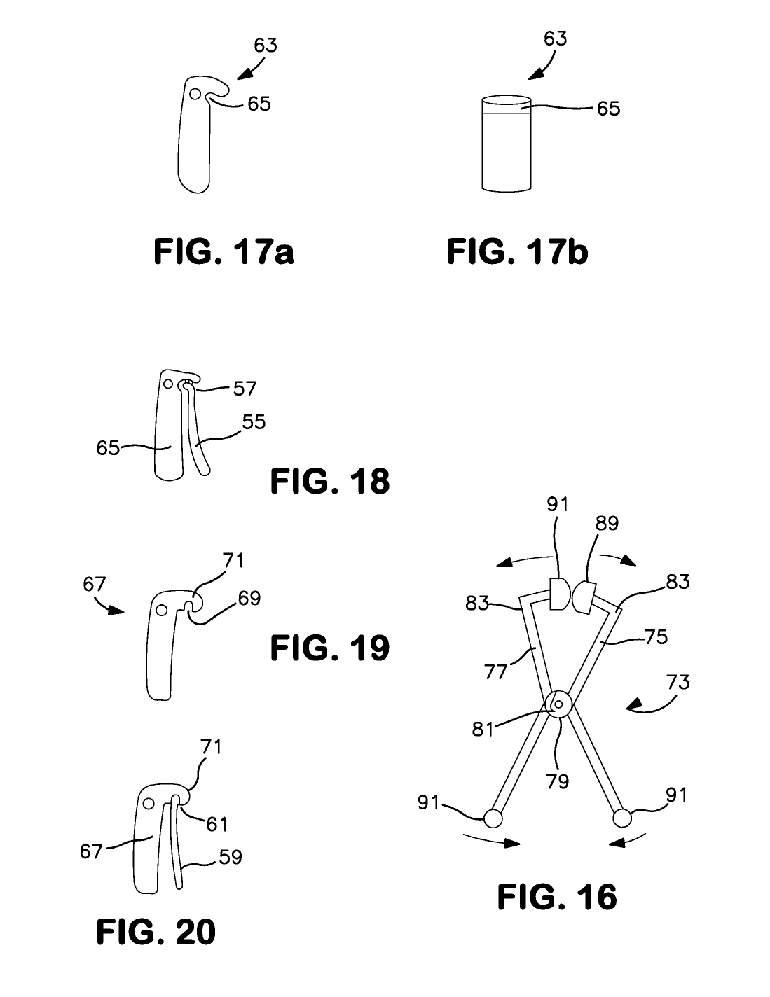

An alternative configuration for the ring clamp 21 is an X-shaped clamp 73, FIGS. 15 and 16. The advantage of this configuration is the leverage offered by the design. The X-clamp 73 can be opened, positioned, re-opened and then removed by finger action, thereby eliminating the need for a tool. The X-clamp has a first and second legs 75, 77, respectively, FIGS. 15 and 16. These legs bend at about mid-length at an angle between 35 and 55 degrees. Preferably the bend angle is about 40 degrees.

The legs 75, 77 are mounted on a pivot structure 79 at the bend location. Each leg 75, 77 has a foot carrying portion in front of the pivot 79 and a handle portion to the rear of the pivot 79. A spring 81 at the pivot 79 biases the front portions of the legs together and the handle portions apart.

The foot portions of the legs 75, 77, each have a 90 degree bend 83 so that the free ends, which carry a foot, face each other. As with the ring clamp 21, each X-clamp 73 has a pair of feet, one each mounted at a free foot carrying portion end. These feet can take many shapes including the shapes described above.

The X-clamp 73 shown in FIG. 15 has its first and second foot 85, 87 with tapered juxtaposed faces. The X-clamp 73 shown in FIG. 16 has its first and second foot 89, 91 with flat juxtaposed faces.

The wedges 29, 31 FIGS. 8b and 9b can be eliminated as shown in FIGS. 17a, 17b, 18, 19, and 20 should a patient's gum gingival configuration not be compatible with the wedge shape. In this instance, the dentist has the option of using commercially available wedges 33.

Likewise, the handle portions of each of the legs 75, 77 can have a finger pad 91 at the handle ends, FIG. 16. These pads 91 facilitate the finger operation by providing a larger surface for finger contact. The also facilitate stability when manually operating the X-clamp 73, FIG. 16.

Many changes can be made in the above-described invention without departing from the intent and scope thereof. It is therefore intended that the above description be read in the illustrative sense and not in the limiting sense. Substitutions and changes can be made while still being within the scope and intent of the invention and of the appended claims.

1. A dental sectional matrix ring clamp assembly, suitable for use in Class II restoration, comprising:
a split ring of spring material acceptable for use in the mouth;
a pair of feet positioned one each on a free end of the split ring;
wherein each foot of pliable material acceptable for use in the mouth; and
wherein at least one of said feet is shaped to hold the top or bottom edges of said sectional matrix.

2. A dental sectional matrix ring clamp assembly according to claim 1 further comprising a pair of gingival projections, one each extending from a respective foot orthogonal thereto to extend toward each other.

3. The clamp assembly of claim 2, also including a sectional matrix sized for the restoration, wherein said ring is expandable to permit said feet to clear a tooth and then be collapsed into contact with two adjoining teeth.

4. The clamp assembly of claim 2, wherein said ring is expandable to permit said gingival projections to clear a tooth and then be collapsed into extending though the gingival margin between two teeth.

5. The clamp assembly of claim 4, wherein said ring expansion also permits said feet to clear a tooth and then be collapsed into contact with two adjoining teeth and said sectional matrix.

6. The clamp assembly of claim 5, wherein at least one of said feet has a C-shaped section formed by a back wall, a projecting top wall and a projecting bottom wall, and wherein said sectional matrix is of spring foil being capable of being held by being wedged into said C-shaped section of said at least one of said feet.

7. The clamp assembly of claim 6, also including a bump out member on the inside of said bottom wall, said bump out and the corner of said back wall with said top wall acting to hold said matrix foil.

8. The clamp assembly of claim 7, wherein when said feet are in contact with said two teeth and in contact with said sectional matrix, said gingival projections overlap each other and press against each other and said section matrix.

9. The clamp assembly of claim 8, wherein said gingival projection have a triangular cross-sectional shape.

10. The clamp assembly of claim 9, wherein said feet and said gingival projections are, respectively, one continuous structure of soft surfaced polymer material.

11. The clamp assembly of claim 10, wherein said split ring is made of stainless steel.

12. The clamp assembly of claim 2, wherein said sectional matrix has a rolled top edge.

13. The clamp assembly of claim 12, wherein said at least one of said feet includes an elongate gutter for receiving and holding said sectional matrix top rolled edge.

14. The clamp assembly of claim 13, wherein said at least one of said feet also includes a projection opposite said elongate gutter, said projection holding said sectional matrix bottom edge.

15. A method of holding a sectional matrix against one of a patient's teeth, comprising the steps of:
selecting a split ring sized to the patient's teeth, said split ring including a pair of feet at the free ends thereof, said feet each having an orthogonal projecting member;
selecting a sectional matrix sized to the patient's teeth;
mounting said sectional matrix on one of said feet to be held there to;
spreading said split ring sufficiently to allow said feet to be clear of said teeth;
positioning said split ring between two teeth, so that when said split ring spread is released, said sectional matrix will seat against one of said teeth, and said feet will seat against said two teeth and the sectional matrix, and said orthogonal projecting members will be positioned in the gingival margin between said two teeth and seat against said sectional matrix; and
releasing said split ring to force said orthogonal projecting member into said gingival margin to be held therein under spring force, wherein said two feet seat against said two teeth and said sectional matrix under spring force.

16. A method according to claim 15 wherein each of said feet includes an orthogonal projecting member, said split ring is spread sufficiently such that said orthogonal projecting members are clear of said teeth, and
said split ring is positioned between two teeth, so that when said split ring spread is released, said orthogonal projecting members will be positioned in the gingival margin between said two teeth and seat against said sectional matrix.

17. A dental sectional matrix X-shaped clamp assembly, suitable for use in Class II restoration, comprising:
a pair of clamp arms each having a bend near mid-length, this bend separating a front foot carrying portion from a rear handle portion of each arm;
a pivot connecting the pair of clamp arms together;
a spring positioned at said pivot biasing the foot carrying portions together and the handle portions apart;
a second bend in the foot carrying portion of each arm, these bends permitting the free ends of the foot carrying portions to face each other; and
a foot mounted to each free end of each foot carrying portion, at least on of said feet being adapted to engage and hold a sectional matrix.
